(19) United States
(12) Patent Application Publication
(10) Pub. No.: US 2022/0311292 A1
(43) Pub. Date: Sep. 29, 2022

(54) ROTARY MOTOR SHEET AND ROTOR

(71) Applicant: Hefei JEE Power Systems Co.,Ltd., Hefei (CN)

(72) Inventors: Lei LIU, Hefei (CN); Renzhong ZHANG, Hefei (CN); Jialun FAN, Hefei (CN); Kun FAN, Hefei (CN)

(73) Assignee: Hefei JEE Power Systems Co.,Ltd., Hefei (CN)

(21) Appl. No.: 17/338,918

(22) Filed: Jun. 4, 2021

(30) Foreign Application Priority Data
Mar. 26, 2021 (CN) 202110330856.5

(51) Int. Cl. H02K 1/27

(52) U.S. Cl. CPC H02K 1/276; H02K 2201/06

(57) ABSTRACT

A rotary motor sheet and rotor are provided. The rotary motor sheet includes a sheet body. The sheet body includes a plurality of magnetic poles distributed in a circumferential direction of the sheet body. Each magnetic pole includes a pair of first magnet grooves and a pair of second magnet grooves symmetrically distributed in a D-axis center line of the each magnetic pole, respectively, and a spacing between the first magnet grooves and a spacing between the second magnet grooves are both widened in an outer circumferential direction of the rotary motor sheet along the D-axis center line of the each magnetic pole. A through hole symmetrical about the D-axis center line of the each magnetic pole is provided between two second magnet grooves, a weight-reducing hole is provided between an incircle of the rotary motor sheet and an area between every two adjacent magnetic poles.

### CROSS REFERENCE TO THE RELATED APPLICATIONS

This application is based upon and claims priority to Chinese Patent Application No. 202110330856.5 filed on Mar. 26, 2021, the entire contents of which are incorporated herein by reference.

### TECHNICAL FIELD

The present invention relates to a motor, in particular to a rotary motor sheet and rotor.

### BACKGROUND

At present, drive motors of new energy vehicles are developing in a direction of high speed and high power density. In order to achieve the high speed, a traditional built-in permanent magnet motor is provided with magnetic bridges on both sides of magnets to increase strength of a rotor, and the higher the speed is, the wider the magnetic bridge is.

In technical solutions of the prior art, the method for realizing high speed by providing magnetic bridges on both sides of the magnet may seriously affect the performance of the motor. The material of the magnetic bridge is silicon steel sheet having a good magnetic permeability, which may on one hand reduce torque of the permanent magnet by increasing the flux leakage of the permanent magnet field and on the other hand reduce torque of the reluctance by reducing the reluctance of the D-axis magnetic circuit. Thus, the provision of the magnetic bridges may inevitably lead to a decrease in motor performance, thereby causing the high power density to be difficult. Therefore, an innovative magnetic circuit design is necessary to achieve the high speed and high power density.

### SUMMARY

An objective of the present invention is to provide a rotary motor sheet and rotor by starting from designing magnetic circuits of the rotor sheet, and the present invention adopts a magnetic circuit substantially in a double V-shape to acquire a high saliency ratio via a preferred V-shaped angle, thereby enabling the permanent magnet motor to have high performance.

The present invention has following technical solutions.

A rotary motor sheet includes a sheet body, and the sheet body includes a plurality of magnetic poles distributed in a circumferential direction of the sheet body, wherein each magnetic pole includes a pair of first magnet grooves and a pair of second magnet grooves, and the two pairs of magnet grooves are assembled with a first magnet and a second magnet, respectively.

The pair of first magnet grooves and the pair of second magnet grooves are symmetrically distributed in a D-axis center line of the magnetic pole, respectively; a spacing between the pair of first magnet grooves and a spacing between the pair of second magnet grooves are both widened in an outer circumferential direction of the sheet along the D-axis center line of the magnetic pole; and a through hole symmetrical about the D-axis center line of the magnetic pole is provided between the two second magnet grooves.

First magnetic bridges are formed between outer ends of the pair of first magnet grooves and an excircle of the sheet, respectively; second magnetic bridges are formed between inner ends of the pair of first magnet grooves; third magnetic bridges are formed between outer ends of the pair of second magnet grooves and the excircle of the sheet, respectively; and fourth magnetic bridges are formed between inner ends of the pair of second magnet grooves and the through hole, respectively.

A weight-reducing hole is provided between an incircle of the sheet and an area between every two adjacent magnetic poles; and a positioning hole is provided between every two adjacent weight-reducing holes.

Preferably, an inner ring of riveting points and an outer ring of riveting points are distributed in the sheet body, and the two rings of riveting points are both disposed on a symmetry line of adjacent magnetic poles of a rotor sheet, wherein the outer ring of riveting points is disposed between adjacent magnetic poles, and the inner ring of riveting points is disposed between the weight-reducing holes and the incircle of the sheet.

Preferably, an angle α1 between the pair of first magnet grooves is greater than an angle α2 between the pair of second magnet grooves.

The angle α1 between the pair of first magnet grooves ranges from 130° to 135°, and the angle α2 of the pair of second magnet grooves ranges from 95° to 105°.

Preferably, a first magnet is provided in the first magnet groove, and a second magnet is provided in the second magnet groove (2), wherein a pole arc angle β1 between the two first magnets ranges from 14° to 15°, a pole arc angle β2 between the two second magnets ranges from 30° to 31°, and a distance D7 from a midpoint of an inner edge of the first magnet to a midpoint of an outer edge of the second magnet corresponding to the first magnet ranges from 5.5 mm to 6.5 mm.

Preferably, upper and lower edges of the through hole are perpendicular to the D-axis center line of the magnetic pole; left and right edges of the through hole are parallel to the D-axis center line; and edges of the through hole have a width ranging from 7 mm to 8 mm.

Preferably, a connecting line between two points of the pair of second magnet grooves, which have a shortest distance to a center point of the sheet, is collinear with the lower edge of the through hole, and a distance D6 between the upper edge of the through hole and a connecting line between two closest points of the pair of second magnets ranges from 2 mm to 2.5 mm.

Preferably, the first magnetic bridge has a width ranging from 0.9 mm to 1.1 mm, the second magnetic bridge has a width ranging from 0.9 mm to 1.1 mm, the third magnetic bridge has a width ranging from 1.4 mm to 1.6 mm, and the fourth magnetic bridge has a width ranging from 1.1 mm to 1.2 mm.

Preferably, an extension line of a long edge of the magnet of the second magnet groove is tangent to the inner end of the second magnet groove.

Preferably, the weight-reducing hole includes five edges, wherein an inner edge is an arc line segment having a center point of the sheet as a circle point, and a distance D2 from the inner edge to the incircle of the sheet ranges from 6.5 mm to 7.5 mm; two middle edges are parallel to each other and have a distance D9 ranging from 12.5 mm to 13.5 mm; two outer edges are parallel to the inner edges of the second magnet groove corresponding to left and right magnetic poles, and a distance D1 from the outer edges to the second magnet groove ranges from 6.5 mm to 7.5 mm; a distance D3 from an outermost point to the excircle of the sheet ranges from 15 mm to 16 mm; and a distance D8 from the outermost point to the inner edge ranges from 18.5 mm to 19.5 mm.

Preferably, the positioning holes are distributed between the weight-reducing holes, wherein two positioning holes are distributed between every two weight-reducing holes symmetric with each other about the center point of the sheet, and one positioning hole is distributed between every other two weight-reducing holes.

Preferably, the number of the magnetic poles is eight, and accordingly, the number of the positioning holes is ten, wherein a first positioning hole is spaced apart from a sixth positioning hole by 180°, a second positioning hole is spaced apart from a seventh positioning hole by 180°, a third positioning hole is spaced apart from an eighth positioning hole by 180°, a fourth positioning hole is spaced apart from a ninth positioning hole by 180°, and a fifth positioning hole is spaced apart from a tenth positioning hole by 180°; and taking the D-axis center line of the magnetic pole corresponding to the first positioning hole as a reference line, angles θ1, θ2, θ3, θ4 and θ5 between the reference line and connecting lines from the center point of the sheet to center points of the first positioning hole, the second positioning hole, the third positioning hole, the fourth positioning hole, and the fifth positioning hole range from 0.5° to 1°, from 41.5° to 42°, from 84° to 84.5°, from 94° to 94.5°, and from 136.5° to 137°, respectively.

Preferably, a distance D5 from the outer ring of riveting points to the excircle of the sheet ranges from 7.5 mm to 8.5 mm, and a distance D4 from the inner ring of riveting points to the incircle of the sheet ranges from 3.5 mm to 4.5 mm.

A rotary motor rotor adopting the rotary motor sheet includes a rotation shaft and a number of rotary motor sheets sleeved on the rotation shaft via the incircles of the sheets, and further includes a positioning screw, wherein multiple segments of skewed poles of the rotor are achieved via cooperation between the positioning holes on the sheet body and the positioning screw.

The number of the multiple segments of the skewed poles of the rotor is six, wherein by taking a first segment as a reference and a counterclockwise direction as positive, as viewed from a sixth segment of an iron core to a first segment of the iron core, rotation angles from a second segment to the sixth segment of the iron core relative to an adjacent previous segment are 2.5°, 2.5°, 1.25°, −2.5°, and −2.5°, respectively.

The present invention has following advantages.

(1) Starting from designing the magnetic circuit of the rotor sheet, the present invention provides a rotary motor sheet, which adopts a magnetic circuit in an approximate double V-shape. Meanwhile, the through hole having a substantially rectangular structure is additionally provided between the pair of second magnet grooves via a preferred V-shaped angle. The through hole can be filled with a non-magnetic material such as resin, plastic or air, which can thereby increase magnetic resistance of the D-axis, such that the motor can have a saliency ratio not less than 2.8 and further have torque and power both increased by at least 10%. Thus, the overall performance of the motor can be improved.

(2) The weight-reducing hole provided between the incircle of the rotor sheet according to the present invention and the magnet can also reduce the weight and improve the power density of the motor while ensuring the electromagnetic performance of the sheet and the strength of the magnet.

(3) According to the rotary motor rotor of the present invention, the multiple segments of the skewed poles of the rotor can be achieved via cooperation between the positioning holes on the sheet body and the positioning screw. Thus, the assembly process is simple, and the efficiency is high.

### BRIEF DESCRIPTION OF THE DRAWINGS

The present invention will be further described with reference to the accompanying drawings and embodiments.

FIG. 1 is a schematic structural diagram of a rotary motor sheet according to the present invention;

FIG. 2 is a schematic structural diagram of a single magnetic pole of the rotary motor sheet according to the present invention;

FIG. 3 is a parameter labeling diagram of a single magnetic pole of the rotary motor sheet according to the present invention;

FIG. 4 is a parameter labeling diagram of a weight-reducing hole of the rotary motor sheet according to the present invention;

FIG. 5 is a parameter labeling diagram of a through hole of the rotary motor sheet according to the present invention;

FIG. 6 is a schematic diagram of angles of positioning holes of the rotary motor sheet according to the present invention; and

FIG. 7 is a schematic diagram of multiple segments of skewed poles of the rotary motor rotor according to the present invention.

Reference numbers in the drawings are described as below: 1—first magnet groove; 101—outer end of the first magnet groove; 102—inner end of the first magnet groove; 2—second magnet groove; 201—outer end of the second magnet groove; 202—inner end of the second magnet groove; 3—first magnet; 4—second magnet; 5—through hole; 6—first magnetic bridge; 7—second magnetic bridge; 8—third magnetic bridge; 9—fourth magnetic bridge; 10—weight-reducing hole; 11—positioning hole; 12—riveting point; and 13—D-axis center line.

### DETAILED DESCRIPTION OF THE EMBODIMENTS

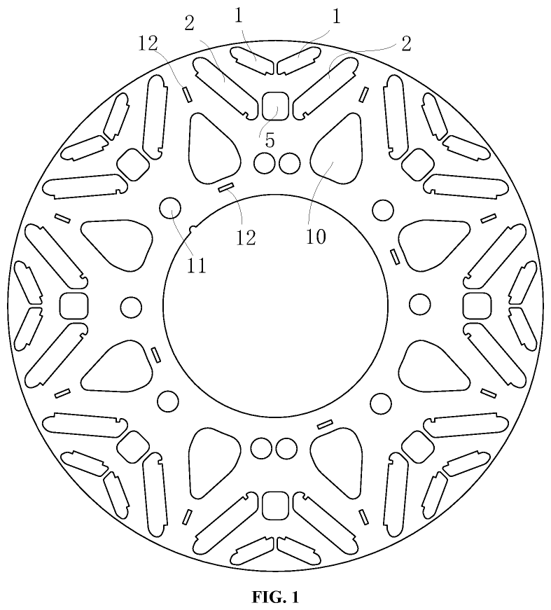

As shown in FIG. 1, the rotary motor sheet according to the present invention includes a sheet body. The sheet body includes a plurality of magnetic poles symmetrically distributed in a circumferential direction of the sheet body, wherein each magnetic pole includes two first magnet grooves 1 in which a first magnet 3 is provided and two second magnet grooves 2 in which a second magnet 4 is provided. After the first magnet grooves 1 and the second magnet grooves 2 are assembled with the magnets, they may both include air portions in outer and inner sides, which namely forms outer ends 101 of the first magnet grooves, inner ends 102 of the first magnet grooves, outer ends 201 of the second magnet grooves, and inner ends 202 of the second magnet grooves.

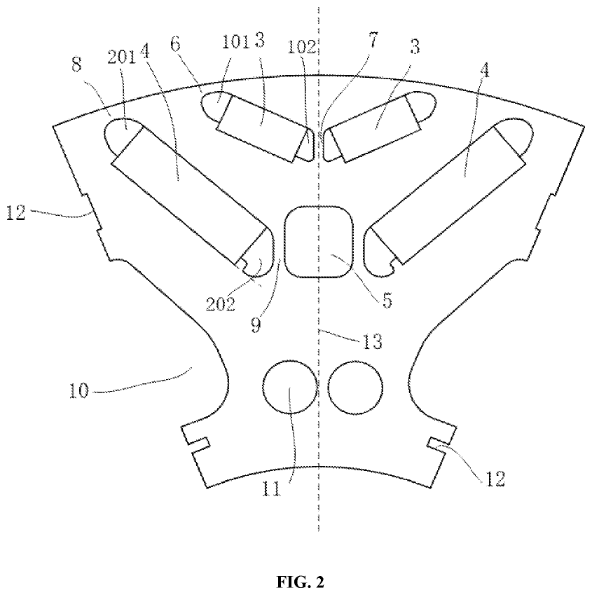

As shown in FIG. 2, the pair of first magnet grooves 1 and the pair of second magnet grooves 2 are both symmetrically distributed in a D-axis center line 13 of the magnetic pole, respectively; a spacing between the pair of first magnet grooves 1 and a spacing between the pair of second magnet grooves 2 are both widened in an outer circumferential direction of the sheet along the D-axis center line 13 of the magnetic pole; and a through hole 5 symmetrical about the D-axis center line 13 of the magnetic pole is provided between the every two second magnet grooves 2. As shown in FIG. 5, the through hole substantially having a rectangular structure is symmetrical about the D-axis center line 13 of the magnetic pole. The through hole 5 can be filled with a non-magnetic material, such as resin or air. Upper and lower edges of the through hole 5 are perpendicular to the D-axis center line 13 of the magnetic pole, and left and right edges the through hole 5 are parallel to the D-axis center line 13. The edges of the through hole 5 parallel and perpendicular to the D-axis center line 13 are 7.5 mm and 7 mm, respectively. A connecting line between two points of the pair of second magnet grooves 2, which have a shortest distance to a center point of the sheet, is collinear with the lower edge of the through hole 5, and a distance D6 from the upper edge of the through hole 5 to a connecting line between two closest points of the pair of second magnets 4 is 2.2 mm.

According the present invention, the through hole 5 that can be filled with the non-magnetic material such as resin or air is additionally provided between the pair of second magnet grooves 2, such that the D-axis reluctance can be increased without affecting the Q-axis reluctance. Therefore, the saliency ratio of the motor can be increased, and the performance of the motor can be improved.

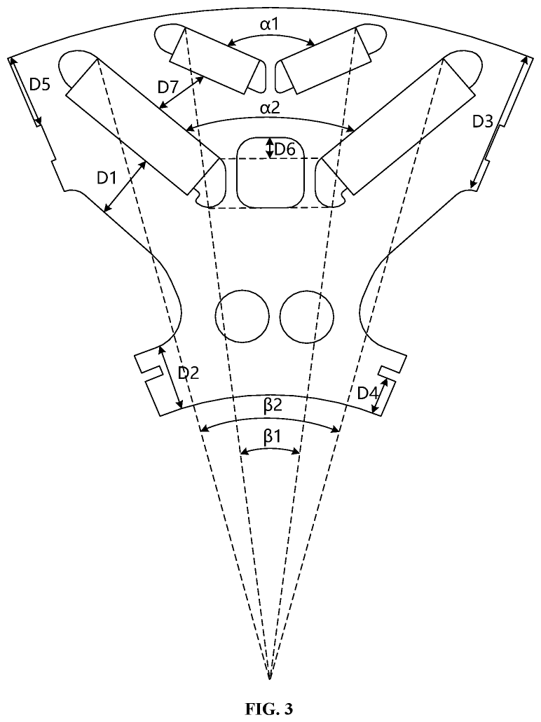

As shown in FIG. 3, an angle α1 between the two first magnet grooves 1 is greater than an angle α2 between the two second magnet grooves 2. The angle α1 between the two first magnet grooves 1 is 131°, and the angle α2 of the two second magnet grooves 2 is 100°. A pole arc angle β1 between the first magnets 3 is 14.6°, a pole arc angle β2 between the second magnets 4 is 30.5°, and a distance D7 from a midpoint of an inner edge of the first magnet 3 to a midpoint of an outer edge of the second magnet 4 corresponding to the first magnet 3 is 6 mm. An extension line of a long edge of the magnet of the second magnet groove 2 is tangent to the inner end 202 of the second magnet groove 2.

Starting from designing the magnetic circuit of the rotor sheet, the present invention provides a rotary motor sheet, which adopts a magnetic circuit substantially in a double V-shape to acquire a high saliency ratio via a preferred V-shaped angle, thereby enabling the permanent magnet motor to have high performance.

First magnetic bridges 6 are formed between outer ends 101 of the first magnet grooves 1 and an excircle of the sheet; second magnetic bridges 7 are formed between inner ends 102 of the first magnet grooves 1; third magnetic bridges 8 are formed between outer ends 201 of the second magnet grooves and the excircle of the sheet; and fourth magnetic bridges 9 are formed between inner ends 202 of the second magnet grooves 2 and the through hole 5. As shown in FIG. 3, the first magnetic bridge 6 has a width of 1 mm, the second magnetic bridge 7 has a width of 1 mm, the third magnetic bridge 8 has a width of 1.5 mm, and the fourth magnetic bridge 9 has a width of 1.15 mm.

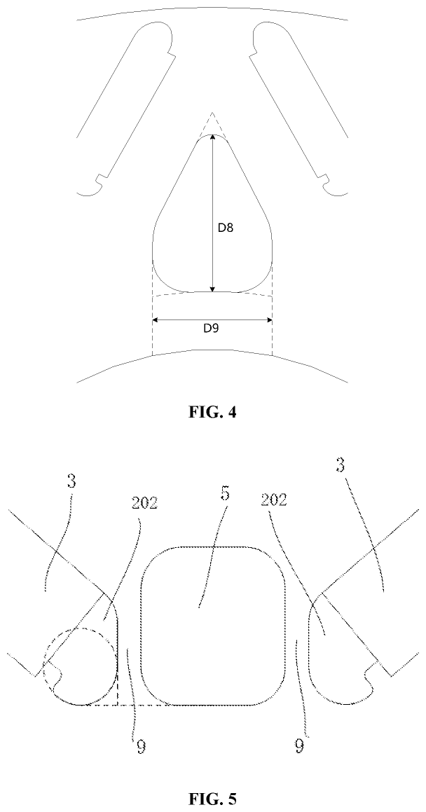

As shown in FIGS. 3-4, weight-reducing holes 10 are provided between the incircle of the sheet and a triangular area between every two adjacent magnetic poles. The weight-reducing hole 10 includes five edges. For the five edges, an inner edge is an arc line segment having a center point of the sheet as a circle point, and a distance D2 from the inner edge to the incircle of the sheet is 7 mm; two middle edges are parallel to each other and have a distance D9 of 13.2 mm; and two outer edges are parallel to the inner edges of the second magnet grooves 2 corresponding to left and right magnetic poles, and a distance D1 from the outer edges to the second magnet grooves 2 is 7 mm. A distance D3 from an outermost point to the excircle of the sheet is 15.4 mm, and a distance D8 from the outermost point to the inner edge is 19 mm. The weight-reducing holes can reduce the weight of the motor and increase the power density.

An inner ring of riveting points 12 and an outer ring of riveting points 12 are distributed in the sheet body, and the riveting points 12 have a rectangular structure with a length of 4 mm and a width of 1 mm. The two rings of riveting points are both disposed on a symmetry line of adjacent magnetic poles of the rotor sheet. The outer ring of riveting points is disposed between adjacent magnetic poles, and the inner ring of riveting points is disposed between the weight-reducing holes 10 and the incircle of the sheet. A distance D5 from the outer ring of riveting points to the excircle of the sheet is 7.9 mm, and a distance D4 from the inner ring of riveting points to the incircle of the sheet is 4 mm.

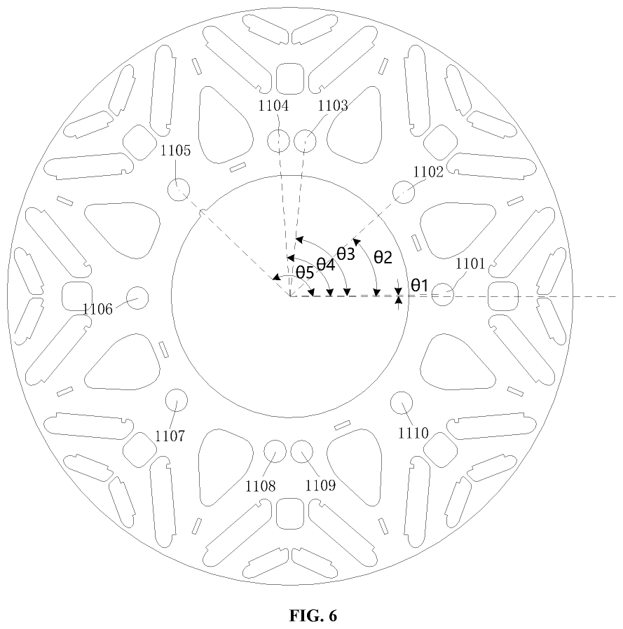

As shown in FIG. 6, positioning holes 11 are provided between adjacent weight-reducing holes 10. Two positioning holes 11 are distributed between every two weight-reducing holes 10 symmetric with each other about the center point of the sheet, and one positioning hole 11 is distributed between every other two weight-reducing holes 10.

According to this embodiment, the number of the magnetic poles is eight, and accordingly, the number of the positioning holes 11 is ten. Here, a first positioning hole 1101 is spaced apart from a sixth positioning hole 1106 by 180°, a second positioning hole 1102 is spaced apart from a seventh positioning hole 1107 by 180°, a third positioning hole 1103 is spaced apart from an eighth positioning hole 1108 by 180°, a fourth positioning hole 1104 is spaced apart from a ninth positioning hole 1109 by 180°, and a fifth positioning hole 1105 is spaced apart from a tenth positioning hole 1110 by 180°. Taking the D-axis center line of the magnetic pole corresponding to the first positioning hole 1101 as a reference line, angles θ1, 02, 03, 04 and 05 between the reference line and connecting lines between the center point of the sheet and center points of the first positioning hole 1101, the second positioning hole 1102, the third positioning hole 1103, the fourth positioning hole 1104 and the fifth positioning hole 1105 range from 0.5° to 1°, from 41.5° to 42°, from 84° to 84.5°, from 94° to 94.5°, and from 136.5° to 137°, respectively.

Further, preferably, 01 is 0.625°, 02 is 41.875°, 03 is 84.375°, 04 is 94.375°, and 05 is 136.875°.

This embodiment further provides a rotary motor rotor, which adopts the rotary motor sheet. The rotary motor rotor includes a rotation shaft and a number of rotary motor sheets sleeved on the rotation shaft via the incircles of the sheets, and further includes a positioning screw, wherein multiple segments of skewed poles of the rotor can be achieved via cooperation between the positioning holes on the sheet body and the positioning screw.

The multiple segments of the skewed poles of the rotor core can be achieved via the cooperation of the positioning holes and one positioning screw in a following manner. By taking a side of the sheet as viewed in FIG. 6 as A side and the other side as the B side, the positioning screw is assembled on the rotation shaft as follows:

for a first segment, the positioning screw is inserted into the positioning hole (1103) on B side;

for a second segment, the positioning screw is inserted into the positioning hole (1102) on B side;

for a third segment, the positioning screw is inserted into the positioning hole (1101) on A side;

for a fourth segment, the positioning screw is inserted into the positioning hole (1101) on B side;

for a fifth segment, the positioning screw is inserted into the positioning hole (1105) on

A side; and

for a sixth segment, the positioning screw is inserted into the positioning hole (1104) on A side.

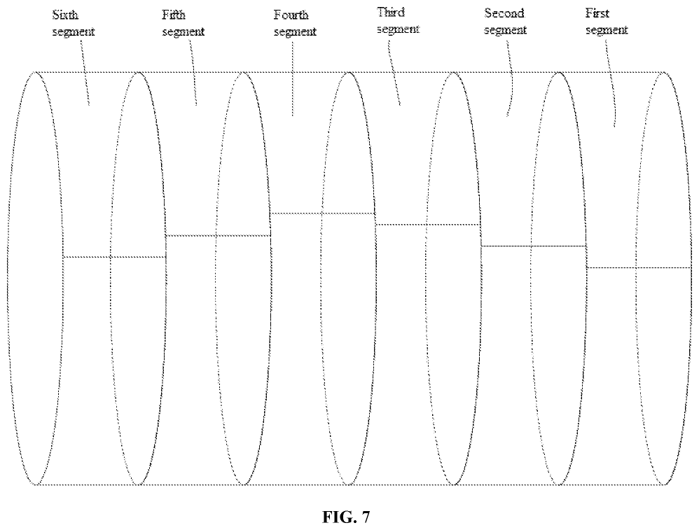

By taking the first segment as a reference and a counterclockwise direction as positive, as viewed from the sixth segment of an iron core to the first segment of the iron core, rotation angles from the second segment to the sixth segment of the iron core relative to an adjacent previous segment are 2.5°, 2.5°, 1.25°, −2.5°, and −2.5°, respectively. FIG. 7 shows the effect after forming the skewed poles. According to the present invention, the multiple segments of the skewed poles of the rotor can be achieved via cooperation between the positioning holes on the sheet body and the positioning screw. Thus, the assembly process is simple, and the efficiency is high.

The foregoing embodiments merely serve to illustrate technical concepts and features of the present invention, and their objective is to enable those skilled in the art to understand the content of the present invention and to implement it accordingly, but not to limit the scope of protection of the present invention. All modifications made according to the spirit essence of the main technical solution of the present invention should be included within the scope of protection of the present invention.

What is claimed is:

1. A rotary motor sheet, comprising a sheet body, the sheet body comprising a plurality of magnetic poles distributed in a circumferential direction of the sheet body, and each magnetic pole comprising a pair of first magnet grooves and a pair of second magnet grooves, wherein
the pair of first magnet grooves and the pair of second magnet grooves are both symmetrically distributed in a D-axis center line of the each magnetic pole, respectively; a spacing between the pair of first magnet grooves and a spacing between the pair of second magnet grooves are both widened in an outer circumferential direction of the rotary motor sheet along the D-axis center line of the each magnetic pole; and a through hole symmetrical about the D-axis center line of the each magnetic pole is provided between the pair of second magnet grooves;
first magnetic bridges are formed between outer ends of the pair of first magnet grooves and an excircle of the rotary motor sheet, respectively; second magnetic bridges are formed between inner ends of the pair of first magnet grooves; third magnetic bridges are formed between outer ends of the pair of second magnet grooves and the excircle of the rotary motor sheet, respectively; and fourth magnetic bridges are formed between inner ends of the pair of second magnet grooves and the through hole, respectively; and
a weight-reducing hole is provided between an incircle of the rotary motor sheet and an area between every two adjacent magnetic poles; and a positioning hole is provided between every two adjacent weight-reducing holes.

2. The rotary motor sheet according to claim 1, wherein an inner ring of riveting points and an outer ring of the riveting points are distributed in the sheet body; and the inner ring and outer ring of the riveting points are all disposed on a symmetry line of adjacent magnetic poles of a rotor sheet, wherein the outer ring of the riveting points is disposed between the adjacent magnetic poles, and the inner ring of the riveting points is disposed between the weight-reducing holes and the incircle of the rotary motor sheet.

3. The rotary motor sheet according to claim 2, wherein an angle α1 between the pair of first magnet grooves is greater than an angle α2 between the pair of second magnet grooves; and
the angle α1 between the pair of first magnet grooves ranges from 130° to 135°, and the angle α2 of the pair of second magnet grooves ranges from 95° to 105°.

4. The rotary motor sheet according to claim 2, wherein a first magnet is provided in each first magnet groove, a second magnet is provided in each second magnet groove, a pole arc angle β1 between a pair of first magnets ranges from 14° to 15°, a pole arc angle β2 between a pair of second magnets ranges from 30° to 31°, and a distance D7 from a midpoint of an inner edge of the first magnet to a midpoint of an outer edge of the second magnet corresponding to the first magnet ranges from 5.5 mm to 6.5 mm.

5. The rotary motor sheet according to claim 4, wherein upper and lower edges of the through hole are perpendicular to the D-axis center line of the each magnetic pole; left and right edges of the through hole are parallel to the D-axis center line; and the edges of the through hole have a width ranging from 7 mm to 8 mm.

6. The rotary motor sheet according to claim 5, wherein a connecting line between two points of the pair of second magnet grooves, wherein the two points have a shortest distance to a center point of the rotary motor sheet, is collinear with the lower edge of the through hole, and a distance D6 from the upper edge of the through hole to a connecting line between two closest points of the pair of second magnets ranges from 2 mm to 2.5 mm.

7. The rotary motor sheet according to claim 2, wherein each first magnetic bridge has a width ranging from 0.9 mm to 1.1 mm, each second magnetic bridge has a width ranging from 0.9 mm to 1.1 mm, each third magnetic bridge has a width ranging from 1.4 mm to 1.6 mm, and each fourth magnetic bridge has a width ranging from 1.1 mm to 1.2 mm.

8. The rotary motor sheet according to claim 4, wherein an extension line of a long edge of the second magnet of each second magnet groove is tangent to the inner end of the each second magnet groove.

9. The rotary motor sheet according to claim 2, wherein each weight-reducing hole comprises an inner edge, two middle edges and two outer edges, wherein the inner edge is an arc line segment having a center point of the rotary motor sheet as a circle point, and a distance D2 from the inner edge to the incircle of the rotary motor sheet ranges from 6.5 mm to 7.5 mm; the two middle edges are parallel to each other and have a distance D9 ranging from 12.5 mm to 13.5 mm; the two outer edges are parallel to inner edges of each second magnet groove corresponding to left and right magnetic poles, and a distance D1 from outer edges to the each second magnet groove ranges from 6.5 mm to 7.5 mm; a distance D3 from an outermost point to the excircle of the rotary motor sheet ranges from 15 mm to 16 mm;
and a distance D8 from the outermost point to the inner edge ranges from 18.5 mm to 19.5 mm.

10. The rotary motor sheet according to claim 2, wherein the positioning holes are distributed between the weight-reducing holes, wherein two positioning holes are distributed between every two weight-reducing holes symmetric with each other about a center point of the rotary motor sheet, and one positioning hole is distributed between every other two weight-reducing holes.

11. The rotary motor sheet according to claim 10, wherein a number of the plurality of magnetic poles is eight, and accordingly, a number of the positioning holes is ten, wherein a first positioning hole is spaced apart from a sixth positioning hole by 180°, a second positioning hole is spaced apart from a seventh positioning hole by 180°, a third positioning hole is spaced apart from an eighth positioning hole by 180°, a fourth positioning hole is spaced apart from a ninth positioning hole by 180°, and a fifth positioning hole is spaced apart from a tenth positioning hole by 180°; and taking the D-axis center line of the each magnetic pole corresponding to the first positioning hole as a reference line, angles θ1, θ2, θ3, θ4 and θ5 between the reference line and connecting lines from the center point of the rotary motor sheet to center points of the first positioning hole, the second positioning hole, the third positioning hole, the fourth positioning hole, and the fifth positioning hole range from 0.5° to 1°, from 41.5° to 42°, from 84° to 84.5°, from 94° to 94.5°, and from 136.5° to 137°, respectively.

12. The rotary motor sheet according to claim 2, wherein a distance D5 from the outer ring of the riveting points to the excircle of the rotary motor sheet ranges from 7.5 mm to 8.5 mm, and a distance D4 from the inner ring of the riveting points to the incircle of the rotary motor sheet ranges from 3.5 mm to 4.5 mm.

13. A rotary motor rotor adopting the rotary motor sheet according to claim 1, comprising a rotation shaft and a number of rotary motor sheets sleeved on the rotation shaft via incircles of the rotary motor sheets, and further comprising a positioning screw, wherein a plurality of segments of skewed poles of the rotary motor rotor are achieved via cooperation between the positioning holes on the sheet body and the positioning screw.

14. The rotary motor rotor according to claim 13, wherein a number of the plurality of segments of the skewed poles of the rotary motor rotor is six, wherein by taking a first segment as a reference and a counterclockwise direction as positive, as viewed from a sixth segment of an iron core to the first segment of the iron core, rotation angles from a second segment to the sixth segment of the iron core relative to an adjacent previous segment are 2.5°, 2.5°, 1.25°, −2.5°, and −2.5°, respectively.

15. The rotary motor rotor adopting the rotary motor sheet according to claim 13, wherein an inner ring of riveting points and an outer ring of the riveting points are distributed in the sheet body; and the inner ring and outer ring of the riveting points are all disposed on a symmetry line of adjacent magnetic poles of a rotor sheet, wherein the outer ring of the riveting points is disposed between the adjacent magnetic poles, and the inner ring of the riveting points is disposed between the weight-reducing holes and the incircle of the rotary motor sheet.

16. The rotary motor rotor adopting the rotary motor sheet according to claim 15, wherein an angle α1 between the pair of first magnet grooves is greater than an angle α2 between the pair of second magnet grooves; and
the angle α1 between the pair of first magnet grooves ranges from 130° to 135°, and the angle α2 of the pair of second magnet grooves ranges from 95° to 105°.

17. The rotary motor rotor adopting the rotary motor sheet according to claim 15, wherein a first magnet is provided in each first magnet groove, a second magnet is provided in each second magnet groove, a pole arc angle β1 between a pair of first magnets ranges from 14° to 15°, a pole arc angle β2 between a pair of second magnets ranges from 30° to 31°, and a distance D7 from a midpoint of an inner edge of the first magnet to a midpoint of an outer edge of the second magnet corresponding to the first magnet ranges from 5.5 mm to 6.5 mm.

18. The rotary motor rotor adopting the rotary motor sheet according to claim 15, wherein upper and lower edges of the through hole are perpendicular to the D-axis center line of the each magnetic pole; left and right edges of the through hole are parallel to the D-axis center line; and the edges of the through hole have a width ranging from 7 mm to 8 mm.

19. The rotary motor rotor adopting the rotary motor sheet according to claim 18, wherein a connecting line between two points of the pair of second magnet grooves, wherein the two points have a shortest distance to a center point of the rotary motor sheet, is collinear with the lower edge of the through hole, and a distance D6 from the upper edge of the through hole to a connecting line between two closest points of the pair of second magnets ranges from 2 mm to 2.5 mm.

20. The rotary motor rotor adopting the rotary motor sheet according to claim 15, wherein each first magnetic bridge has a width ranging from 0.9 mm to 1.1 mm, each second magnetic bridge has a width ranging from 0.9 mm to 1.1 mm, each third magnetic bridge has a width ranging from 1.4 mm to 1.6 mm, and each fourth magnetic bridge has a width ranging from 1.1 mm to 1.2 mm.
